(19) United States
(12) Patent Application Publication
(10) Pub. No.: US 2020/0403236 A1
(43) Pub. Date: Dec. 24, 2020

(54) CONTINUOUS PROCESSING CHAMBERS

(71) Applicant: CAMX Power LLC, Lexington, MA (US)

(72) Inventor: John Warren Colwell, Lexington, MA (US)

(21) Appl. No.: 16/448,983

(22) Filed: Jun. 21, 2019

(51) Int. Cl. H01M 4/505; C01G 53/00; B01J 6/00; H01M 4/525; F27B 9/04

(52) U.S. Cl. CPC H01M 4/505; C01G 53/44; C01P 2006/40; H01M 4/525; F27B 9/045; B01J 6/004

(57) ABSTRACT

This disclosure is directed to a continuous processing chamber that includes: a material shaft through which the material introduced by an inlet may be transported and discharged through an outlet; optionally an inner gas transfer tube in fluid communication with the material shaft with an inner filtration wall that encases at least a portion of the inner gas transfer tube and is in fluid communication with both the material shaft and the inner gas transfer tube; optionally an outer filtration wall that encases at least a portion of the material shaft and is in fluid communication with the material shaft and associated with an outer gas transfer tube. The continuous processing chamber may be incorporated into methods for treating the material to produce a lithiated product.

### FIELD

This disclosure is directed to apparatuses capable of treating materials and methods that incorporate such apparatuses.

### BACKGROUND

Multiple variations of furnace technologies for the continuous processing of powder and granular materials including both horizontal (i.e., belt, rotary, pusher, roller hearth, etc.) kilns and vertical (i.e., lime and coke processing kilns, etc.) kilns are currently in use. However, both of these types of kilns present a variety of problems when tasked with processing such materials. For example, typical horizontal kilns are inherently inefficient when utilizing process gases as the process gases are not passed through the powder bed. As such, horizontal kilns commonly result in significant unused space within the furnace chambers.

Typical vertical kilns are also inefficient when processing small particle size (i.e., diameter smaller than 1 mm) materials with significant (i.e., greater than 10%) off-gassing. In such conditions, the vertical kilns suffer from pressure drops that are not practical for operation. Typical vertical kilns, however, are also not practical when chemical reactions that occur in such a kiln require a high degree of atmospheric control since the off gasses and process gasses cannot pass through the entire bed and the atmosphere cannot be controlled at the specific points of the reaction. For example, a high degree of atmospheric control is required during the calcination process of the production of various battery materials (i.e., lithium cobalt oxide, lithium nickel manganese cobalt oxide, lithium nickel cobalt aluminum oxide, lithium nickel oxide, lithium iron phosphate, and the like). The particle size of the various battery materials is also sufficiently small such that gases cannot realistically pass through the entire height of the powder bed of the vertical furnaces, which are needed to treat the cathode battery materials. Therefore, each of the above-mentioned typical kilns suffer from their own individual strengths and weaknesses, which makes them suitable for only some chemistries and processes while not being suitable for others.

One example of a furnace technology directed to overcome such weaknesses is the Roller Hearth Kiln (RHK), which is a standard processing equipment for production of battery materials. These long (i.e., ˜50 m) horizontal kilns include various reaction zones to ensure that atmospheric compositions may be controlled at different stages along the reaction and provide desired heat uniformity to the product when crucibles of powder are passed through the furnace.

While RHKs may have a high throughput, they typically utilize a significant amount of floor space, often amounting to hundreds of square meters. Further, RHKs are expensive pieces of equipment and require both a large initial investment and continued capital costs for equipment replacements and energy upkeep. Moreover, RHKs incorporate complex material handling systems designed to load and unload the ceramic crucibles.

Therefore, alternative battery production furnace systems are desired.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

Provided is a continuous processing chamber for the treatment of a material. The continuous processing chamber includes a material shaft that is configured so that a material may be introduced by an inlet of the material shaft and discharged through an outlet of the material shaft. The continuous processing chamber further includes an inner gas transfer tube, an outer gas transfer tube or both. Optionally an inner gas transfer tube is provided in fluid communication with the material shaft, and the inner gas transfer tube is optionally configured such that a gas may be introduced to the material shaft though the inner gas transfer tube. The inner gas transfer tube further includes an inner filtration wall that encases at least a portion of the inner gas transfer tube and is in fluid communication with both the material shaft and the inner gas transfer tube. In some aspects, the continuous processing chamber includes an outer filtration wall that encases at least a portion of the material shaft and is in fluid communication with the material shaft. Optionally, the continuous processing chamber includes an outer gas transfer tube configured such that a gas may be exhausted from the material shaft. The outer filtration wall optionally forms or encases at least a portion of the outer gas transfer tube and is in fluid communication with both the material shaft and the outer gas transfer tube. In some aspects, the continuous processing chamber further includes a thermally-conductive shell that encases at least a portion of the material shaft, the inner gas transfer tube, the inner filtration wall, the outer filtration wall, the outer gas transfer tube, or combinations thereof. The inner filtration wall and the outer filtration wall are porous to a gas and the processing chamber is configured to allow the gas fed to the material shaft through the gas transfer tube(s) to contact the material, thereby treating the material.

In some embodiments, the inner filtration wall and the outer filtration wall include porous media. The porous media may include any materials having a pore size sufficiently small so as to prevent occlusion of the pores by the material being processed while allowing a gas to pass through the filtration wall. A gas may further be supplied to or removed from the material shaft by the inner gas transfer tube and the outer gas transfer tube, which are fluidly coupled to the material shaft via the inner filtration wall and/or outer filtration wall. The inner gas transfer tube may be inserted in the material shaft, ideally central to a cross section of the material shaft. Optionally, the gas is supplied through the inner gas transfer tube by passing through the inner filtration wall and exhausted via the outer gas transfer tube through the outer filtration wall.

In some embodiments, the inner filtration wall or the outer filtration wall may be continuously positioned, separated, or zoned to allow for increased atmospheric control of the continuous processing chamber. The inner filtration wall may be positioned contiguously with the inner gas transfer tube or may be nested inside the inner gas transfer tube to ensure that the gas is supplied and/or removed from the material shaft. Similarly, the outer filtration wall may be positioned contiguously with the outer gas transfer tube or may be nested inside the outer gas transfer tube to ensure that the gas is supplied and/or removed from the material shaft. A cross-section of the inner gas transfer tube or the outer gas transfer tube may be circular or any other suitable shape. The inner gas transfer tube or the outer gas transfer tube may also be tapered along a length of the material shaft. The inner gas transfer tube or the outer gas transfer tube may occupy at least a partial length of the material shaft.

In some embodiments, the inner gas transfer tube supplies gas to the material shaft and the outer gas transfer tube supplies no gas to the material shaft. Rather, the outer gas transfer tube extracts gas introduced by the inner gas transfer tube via the inner filtration wall and/or reaction off-gas.

In other embodiments, the outer gas transfer tube supplies gas to the material shaft and the inner gas transfer tube supplies no gas to the material shaft. Rather, the inner gas transfer tube extracts gas introduced by the outer gas transfer tube via the outer filtration wall and/or reaction off-gas.

In some embodiments, neither the inner nor outer gas transfer tubes supply gas to the material shaft. Rather reaction off-gas is removed through either or both gas transfer tube.

In yet other embodiments, both the inner gas transfer tube and the outer gas transfer tube both supply gas to the material shaft.

In certain embodiments, the porous media includes a ceramic. In another embodiments the porous media includes a coated metal, optionally the coated metal includes micropores.

Any of the previous embodiments may be incorporated into a method of treating the material in the continuous processing chamber. The methods may include contacting the material in the continuous processing chamber with a gas to produce a lithiated product.

### BRIEF DESCRIPTION OF THE DRAWINGS

The aspects set forth in the drawings are illustrative and exemplary in nature and not intended to limit the subject matter defined by the claims. The drawings are not intended to be to scale, but to illustrate various aspects of the device as otherwise described herein. Like numerals are maintained throughout the drawings. The following detailed description of the illustrative aspects can be understood when read in conjunction with the following drawings and in which:

FIG. 1 is a schematic perspective view of a horizontal cross-section of a continuous processing chamber as provided according to one or more embodiments described herein; and

FIG. 2 is a schematic perspective view of a vertical cross section of a continuous processing chamber as provided according to one or more embodiments described herein.

### DETAILED DESCRIPTION

The following description of particular embodiments is merely exemplary in nature and is in no way intended to limit the scope of the disclosure, its application, or uses, which may vary. The materials and processes are described with relation to the non-limiting definitions and terminology included herein. These definitions and terminology are not designed to function as a limitation on the scope or practice of the disclosure but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, unless specified otherwise, “a first element,” “component,” “region,” “layer,” or “section” discussed below could be termed a second (or other) element, component, region, layer, or section without departing from the teachings herein.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

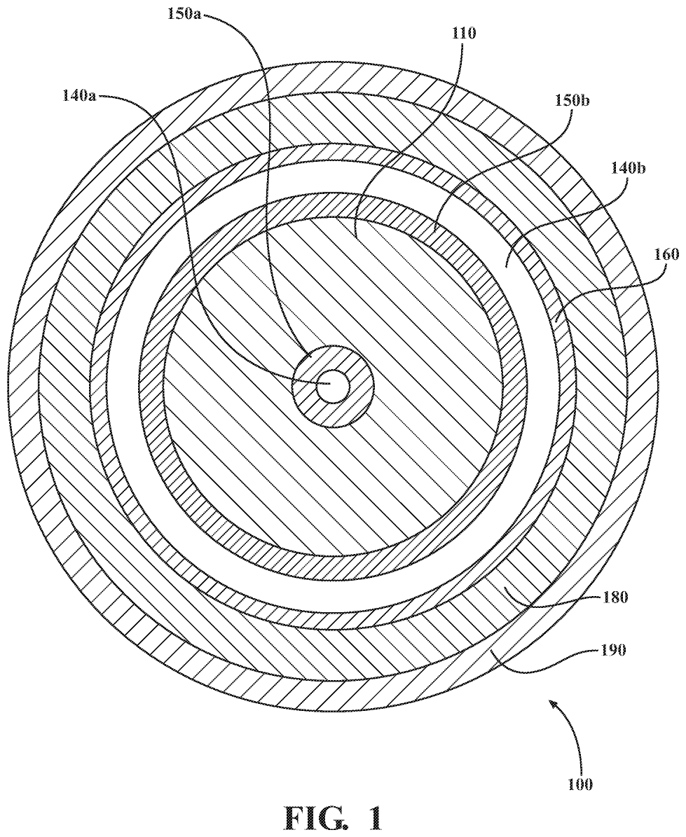

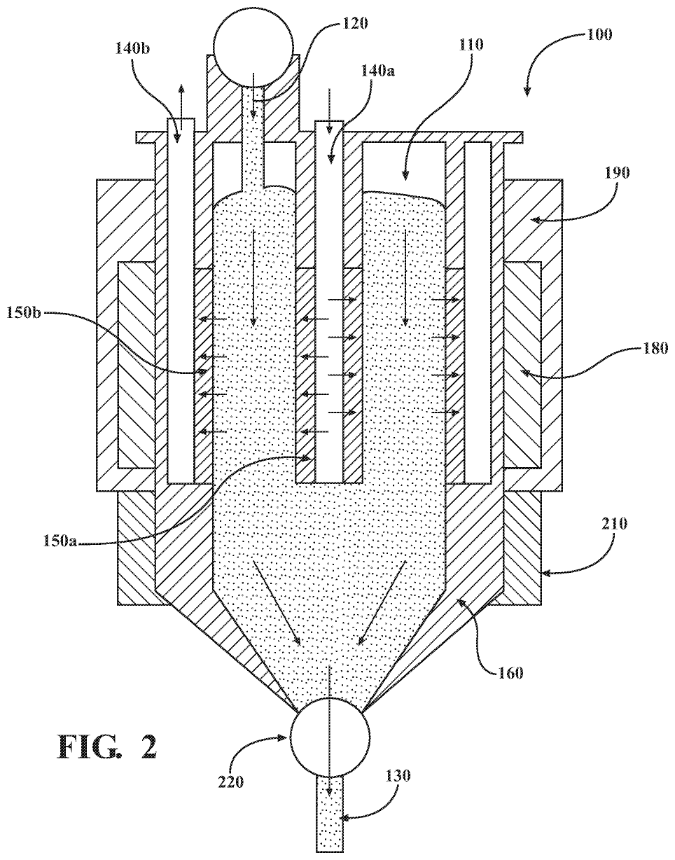

FIGS. 1 and 2 depict an exemplary continuous processing chamber 100 for the treatment of a material as provided according to some embodiments as described herein. A continuous processing chamber 100 includes a material shaft 110, to which the material is introduced by an inlet 120. The inlet 120 may be configured in such a way as to ensure uniform distribution of the feed material throughout the cross section of the material shaft 110. The material is then transported through the material shaft 110 and is discharged through an outlet 130. During operation, and upon the material being introduced to the continuous processing chamber 100, the material shaft 110 houses a material bed where the material is treated. An inner gas transfer tube 140a is in fluid communication with the material shaft 110. An inner filtration wall 150a encases at least a portion of the inner gas transfer tube 140a and is in fluid communication with both the material shaft 110 and the inner gas transfer tube 140a. An outer filtration wall 150b encases at least a portion of the material shaft 110 and is in fluid communication with the material shaft 110. An outer gas transfer tube 140b encases at least a portion of the outer filtration wall 150b and is in fluid communication with both the material shaft 110 and the outer filtration wall 150b. A thermally-conductive shell 160 encases at least a portion of the material shaft 110, the inner gas transfer tube 140a, the inner filtration wall 150a, the outer filtration wall 150b, the outer gas transfer tube 140b, or combinations thereof. The inner filtration wall 150a and the outer filtration wall 150b are porous to a gas 170. In embodiments, the gas 170 is introduced to the material shaft 110 through the inner gas transfer tube 140a. In other embodiments, the gas 170 is exhausted from the material shaft 110 through the outer gas transfer tube 140b. The continuous processing chamber 100 is configured to allow the gas 170 fed to the material shaft 110 during operation to contact the material, thereby treating the material.

A heating apparatus 180 may optionally be added along the thermally-conductive shell 160 and be in thermal communication with the material shaft 110. In embodiments that include it, the heating apparatus 180 is capable of heating any or all of the components of the continuous processing chamber 100. In some embodiments, the heating apparatus 180 may be at least partially encased with lining 190 to provide additional insulation to any of the components of the continuous processing chamber 100.

Without being bound by theory, it is believed that the continuous processing chamber 100 provides a suitable apparatus for processing battery materials. As such, in embodiments, the material introduced to the material shaft 110 by the inlet 120 may include lithium, a metal hydroxide, or combinations thereof. The material may be introduced to the material shaft 110 in powdered form, granular form, or any other form suitable for treatment within the continuous processing chamber 100. Optionally, the material is in powder form such as in the form of a plurality of particles of average cross sectional dimension being less than 500 micrometers.

In embodiments, the metal hydroxide may include any suitable mixed metal hydroxide. A mixed metal hydroxide may be the result of a co-precipitation reaction according to any known methods. The mixed metal hydroxide may include one or more elements, illustratively: aluminum, magnesium, cobalt, manganese, calcium, strontium, zinc, titanium, yttrium, chromium, molybdenum, iron, vanadium, silicon, gallium, boron, a rare earth element, or any combination thereof. Optionally, the mixed metal hydroxide includes nickel as a predominant element. For example, the mixed metal hydroxide may include nickel at greater than or equal to 80 atomic percent (at %), based on the atomic weight of the mixed metal hydroxide. The mixed metal hydroxide is reacted with lithium (i.e., lithium hydroxide) in a lithiation reaction in the material shaft 110 to produce a lithiated product. The lithiated product may include any suitable materials found in typical lithium-ion batteries.

Specific examples of the lithiated product may include any lithiated species suitable for inclusion in typical lithium-ion batteries, illustratively: lithium cobalt oxide, lithium manganese oxide, lithium nickel manganese cobalt oxide, lithium nickel cobalt manganese oxide, lithium nickel cobalt magnesium oxide, lithium iron phosphate, lithium nickel cobalt aluminum oxide, lithium titanate, or combinations thereof. In some illustrative embodiments, the lithiated product includes lithiated nickel materials, such as lithium nickel cobalt magnesium oxide or lithium nickel cobalt manganese oxide, in which nickel is included in the one or more products at greater than or equal to 80 at. %, based on the total metal of the lithiated product.

In some embodiments, the material fed to the inlet 120 may include a lithiated metal oxide, a coating precursor, and a lithium source. Without being bound by theory, it is believed that the continuous processing chamber 100 may enable the synthesis of coated cathode active materials. Optionally, the material includes a lithium nickel oxide-based material that substantially coated by a coating precursor including cobalt with lithium nitrate as a lithium source. Optionally, the coating precursor includes cobalt and aluminum. Optionally, the coating precursor is substantially free of cobalt.

Upon introducing the material to the material shaft 110, the material is transported through the material shaft 110 by a natural force, an artificial force, or combinations thereof. In certain embodiments, the material is transported through the material shaft 110 by a natural force, such as gravity. In other embodiments, the material is transported through the material shaft 110 by an artificial force, such as a moving bed, a screw, a vacuum, or a conveyer belt. In certain embodiments, the material may be transported through the material shaft 110 by a natural force, such as gravity, and further aided by an artificial force, such as a vacuum.

During operation, the heating apparatus 180 may heat the material shaft 110 to any temperature suitable for processing the materials. Suitable heating apparatuses may include, but are not limited to, resistance heaters, radiative heaters, or combinations thereof. In embodiments, the heating apparatus 180 heats the material shaft 110 to temperatures greater than 500° C. In further embodiments, the heating apparatus 180 heats the material shaft 110 to temperatures greater than 600° C., 700° C., 800° C., 900° C., 1,000° C., 1,250° C., 1,500° C., 1,750° C., 2,000° C., 2,250° C., or 2,400° C. As such, it is necessary for the inner filtration wall 150a and the outer filtration wall 150b to maintain their structural integrity at temperatures greater than 500° C.

In some exemplary embodiments, the inner filtration wall 150a or the outer filtration wall 150b include porous media. As used herein, the term “porous media” is defined to include any material that contains pores or other passages that are sufficiently small enough to prevent the porous media from unwanted occlusion. The inner filtration wall 150a or the outer filtration wall 150b may include any materials suitable for maintaining its structural integrity at temperatures greater than 500° C. Suitable materials for the inner filtration wall 150a or the outer filtration wall 150b may include, but are not limited to, cement, ceramic, metal, coated metal, or combinations thereof. Specific examples of suitable ceramics may include, but are not limited to, silicon carbide, alumina, silicon dioxide, cordierite, mullite, or combinations thereof. In embodiments, the inner filtration wall 150a or the outer filtration wall 150b include ceramic, wherein the ceramic comprises mullite, alumina, or combinations thereof. In certain embodiments, the inner filtration wall 150a or the outer filtration wall 150b include ceramic, wherein the ceramic is alumina. The inner filtration wall 150a or the outer filtration wall 150b, in embodiments, include the same porous media or different porous media.

The outer filtration wall 150b may have an outer diameter suitable for either partially or completely encasing the material shaft 110. Without being bound by theory, it is believed that such a configuration allows a suitable amount of gas 170 to enter the material shaft 110 through the inner filtration wall 150a such that the material being passed through the material shaft 110 is sufficiently treated. Optionally, the flow direction of the gas is substantially orthogonal to the flow direction of the material within the material shaft. In embodiments, the outer diameter of the outer filtration wall 150b is from 100 mm to 750 mm, or any range therebetween. In other embodiments, the outer diameter of the outer filtration wall 150b is from 150 mm to 750 mm, from 200 mm to 750 mm, from 250 mm to 750 mm, from 300 mm to 750 mm, from 400 mm to 750 mm, from 450 mm to 750 mm, from 500 mm to 750 mm. In further embodiments, the outer diameter of the outer filtration wall 150b is greater than 100 mm, 250 mm, 400 mm, 500 mm, 600 mm, or 750 mm.

However, in certain embodiments, the outer diameter of the outer filtration wall 150b may be much larger than 750 mm, such as 100 cm or even 500 cm, if, for example, the continuous processing chamber 100 were implemented in large scale manufacturing systems. Theoretically, the only limit on the outer diameter of the outer filtration wall 150b is that the continuous processing chamber 100 is still capable of suitably treating the material during use.

The inner filtration wall 150a or the outer filtration wall 150b in embodiments, have a porosity that allows a suitable amount of gas to be passed through it such that the material is sufficiently treated. As used herein, the term “porosity” is defined as a measure of the void (i.e. “empty”) spaces in the inner filtration wall 150a or the outer filtration wall 150b, and quantified as a fraction of the volume of voids over the total volume. In embodiments, the inner filtration wall 150a or the outer filtration wall 150b have a porosity from 10% by volume (vol. %) to 90 vol. %, or any range therebetween. In other embodiments, the inner filtration wall 150a or the outer filtration wall 150b have a porosity from 35 vol. % to 85 vol. %, from 40 vol. % to 80 vol. %, from 45 vol. % to 75 vol. %, or from 50 vol. % to 70 vol. %. The inner filtration wall 150a or the outer filtration wall 150b, in embodiments, have the same porosity or different porosities.

The flow of the gas 170 may be optimized to suitable levels such that desired reaction conditions to sufficiently treat the material are achieved. In embodiments, the flow of the gas 170 may be less than the amount of gas 170 necessary to fluidize the material in the continuous processing chamber 100. In certain embodiments, the flow of the gas 170 may be radial to the material shaft 110. In other embodiments, the gas 170 may be introduced to the material shaft 110 radially, but extracted from the material shaft 110 vertically. This variable gas flow may be accomplished by segmenting the inner filtration wall 150a and/or the outer filtration wall 150b at desired locations.

The inner gas transfer tube 140a is in fluid communication with the inner filtration wall 150a and the outer gas transfer tube 140b is in fluid communication with the outer filtration wall 150b. In some embodiments, the inner gas transfer tube 140a introduces the gas 170 to the material shaft 110 via the inner filtration wall 150a. In other embodiments, the outer gas transfer tube 140b introduces the gas 170 to the material shaft 110 via the outer filtration wall 150b. In further embodiments, both the inner gas transfer tube 140a and the outer gas transfer tube 140b introduce the gas 170 to the material shaft 110.

In embodiments, the inner gas transfer tube 140a extracts the gas 170 from the material shaft 110 via the inner filtration wall 150a. In other embodiments, the outer gas transfer tube 140b extracts the gas 170 from the material shaft 110 via the outer filtration wall 150b. In further embodiments, both the inner gas transfer tube 140a and the outer gas transfer tube 140b extract the gas 170 from the material shaft 110.

In certain embodiments, the inner gas transfer tube 140a introduces the gas 170 to the material shaft 110 via the inner filtration wall 150a while the outer gas transfer tube 140b extracts the gas 170 from the material shaft 110 via the outer filtration wall 150b. In yet other embodiments, the inner gas transfer tube 140a extracts the gas 170 from the material shaft 110 via the inner filtration wall 150a while the outer gas transfer tube 140b introduces the gas 170 to the material shaft 110 via the outer filtration wall 150b.

In certain embodiments, the continuous processing chamber 100 may include multiple inner gas transfer tubes 140a. Optionally, each inner or outer gas transfer tube includes more than one section with a filtration wall such that gas may be delivered to the material in more than one location. Optionally, gas may be transferred to the material through more than one inner gas transfer tube. Without being bound by theory, it is believed that the inclusion of multiple inner gas transfer tubes 140a (as an example) would allow the gas 170 to be more easily distributed throughout a large scale system. For example, a large outer filtration wall 150b may be in fluid communication with four variously dispersed inner gas tubes 140a. Further embodiments may also include multiple outer gas tubes 140b to increase the rate at which the gas 170 may be removed from the continuous processing chamber 100. Regardless of the configuration selected, the material shaft 110 may be formed as an annulus between the inner gas tube 140a and the outer gas tube 140b.

The continuous processing chamber 100, according to certain embodiments, may include only (a) the inner gas transfer tube 140a and the inner filtration wall 150a or (b) the outer gas transfer tube 140b and the outer filtration wall 150b. It is contemplated that only one of these sets (i.e., the inner set or the outer set) may be necessary to produce a fully functional continuous processing chamber 100. More specifically, the gas 170 may be introduced to the continuous processing chamber 100 via separate additional openings suitable for dispersing the gas 170 through the continuous processing chamber 100. Alternatively, the gas 170 may be exhausted from the continuous processing chamber 100 via separate additional openings suitable for exhausting the gas 170 from the continuous processing chamber 100. These openings are not shown in FIG. 1 or 2.

As can be seen in FIG. 2, the gas 170 may be introduced in a Gas Flow Direction from the inner gas transfer tube 140a through the inner filtration wall 150a to the material shaft 110 and extracted by the outer gas transfer tube 140b through the outer filtration wall 150b. Without being bound by theory, it is believed that such embodiments may increase the flow of gas within the continuous processing chamber 100. In some embodiments, the inner gas transfer tube 140a and/or the outer gas transfer tube 140b may be tapered or segmented along a length of the material shaft 110 in order to increase or decrease pressure and flow of the gas 170 within the inner gas transfer tube 140a and/or the outer gas transfer tube 140b.

In some embodiments, the gas 170 may be any gas suitable for treating the material passed through the material shaft 110. Suitable examples of gases may include, but are not limited to, oxygen, nitrogen, argon, carbon dioxide, hydrogen, krypton, methane, ethane, propane, butane, helium, neon, or combinations thereof. In certain embodiments, the gas 170 includes atmospheric air. In certain embodiments, the gas 170 includes oxygen.

The thermally-conductive shell 160 provides the structural support and may provide thermal conductivity to any or all of the components of the continuous processing chamber 100. Suitable materials for the thermally-conductive shell 160 may include any thermally-conductive materials capable of withstanding temperatures of 500° C. or greater. As used herein, the term “thermally-conductive” means any material having a thermal conductivity of at least 30 watts per meter-kelvin (W·m⁻¹·K⁻¹). In embodiments, the thermally-conductive shell 160 comprises copper, aluminum, brass, silver, gold, iron, steel, inconel, or combinations thereof. Without being bound by theory, it is believed that a higher thermal conductivity is desirable because such embodiments allow for the material treated within the continuous processing chamber 100 to be treated at higher temperatures, thereby enhancing its treatment properties.

In embodiments, the continuous processing chamber 100 further includes a cooling portion 210 that at least partially encases thermally-conductive shell 160. The cooling portion 210 may be mechanically controlled so that it may selectively cool any or all of the continuous processing chamber 100 at any point of the treatment process. Suitable cooling portions 210 may include, but are not limited to, passive cooling apparatuses (i.e., natural convection), active cooling apparatuses (i.e., forced convection), or combinations thereof. Passive cooling apparatuses may include, but are not limited to, heat sinks that absorb or dissipate heat passively. Active cooling apparatuses may include, but are not limited to, thermoelectric coolers (TECs), fans, coolants, or combinations thereof which may be used to optimize thermal management at any point of the treatment process.

Once the material has been sufficiently treated within the continuous processing chamber 100, it may be removed from the material shaft 110 through a metered discharge mechanism 220 and ultimately extracted via the outlet 130. The metered discharge mechanism 220 controls the residence time of the material such that the material may be continuously replenished from the inlet 120 of the continuous processing chamber 100.

A method of treating the material in the continuous processing chamber 100, according to any of the previously described embodiments, is also contemplated in this disclosure. The methods of treating the material in the continuous processing chamber 100 may include contacting the material in the continuous processing chamber with a gas to produce a lithiated product.

The material may be treated in the material shaft 110 of the continuous processing chamber 100 for any suitable length of time to produce the previously described lithiated product. In embodiments, the material is treated from 10 minutes to 24 hours, or within any range between 10 minutes and 24 hours. In embodiments, the material is treated for about 12 hours.

Similarly, the material may be treated in the material shaft 110 of the continuous processing chamber 100 at any suitable temperature to produce the lithiated product. In embodiments, the material is treated at 500° C. to 2,400° C., or within any range between 500° C. and 2,400° C.

Any suitable gas may be used during the treatment of the material as long as the desired lithiated product is produced using the described methods. In embodiments, the gas includes oxygen, nitrogen, argon, carbon dioxide, hydrogen, krypton, methane, ethane, propane, butane, helium, neon, or combinations thereof. In certain embodiments, the gas includes oxygen.

Upon contacting the material in the continuous processing chamber with the gas, the lithiated product is formed. A suitable lithiated product includes any materials that are found in typical lithium-ion batteries. Illustratively, these materials may include lithium carbonate, lithium cobalt oxide, lithium manganese oxide, lithium nickel manganese cobalt oxide, lithium nickel cobalt manganese oxide, lithium nickel cobalt magnesium oxide, lithium iron phosphate, lithium nickel cobalt aluminum oxide, lithium titanate, or combinations thereof. In certain embodiments, the lithiated product includes lithium nickel cobalt manganese oxide, lithium nickel cobalt magnesium oxide, or combinations thereof. In further embodiments, the lithiated product includes greater than or equal to 80 at. %, based on the entire atomic weight of the lithiated product.

### EXAMPLES

### Example 1: Calcination of Lithium Nickel Cobalt Manganese Oxide

A mixture of lithium hydroxide, lithium carbonate, and a mixed metal hydroxide is blended to a desired composition for standard calcination. The continuous processing chamber is heated to 770° C. and filled with the mixture such that the filtration walls are covered by a height two times greater than that of the material width to avoid fluidization of a top portion of the material shaft. Oxygen is supplied as the gas to the 6 meter long material shaft and passed through the filtration walls and material shaft, and is exhausted from the material shaft. The material is discharged from the material shaft at a rate that ensures that a suitable target residence time and temperature profile of the material within the heating zones. The material is replenished at the same rate. Once the material achieves a steady flow rate, the material is collected as a product. The below table indicates a suitable continuous processing chamber conditions for the lithium nickel cobalt manganese oxide calcination, described above.

TABLE 1
General Parameters for Example 1

| Parameter | Measurement | Units |
|---|---|---|
| Production Rate | 54 | kg/hr |
| Process Gas | O₂ | |
| Material Particle Size | 15 | μm (d50) |
| Residence Time | 12 | hrs |
| Temperature | 770 | ° C. |
| Material Output Temperature | ≤200 | ° C. |
| Material shaft Height | 6 | m |
| Material shaft Internal Diameter | 0.3 | m |
| Filtration Wall Material | Alumina | |
| Filtration Wall Pore Size | ≤1 | μm |
| Gas Flow Required (atm pressure) | 2 | m³/hr |
| Pressure Drop | 1.4 | Bar |

### Example 2: Roast of Lithium Nickel Cobalt Manganese Oxide

The furnace may also be used for a roasting process of the feedstock referenced in Example 1 utilizing the same process description. The roasting process may occur at lower temperature and higher throughput as full sintering of the material does not occur during this step.

The below table indicates the numerical model conditions for a typical lithium nickel cobalt manganese oxide roast.

TABLE 2
General Parameters for Example 2

| Parameter | Measurement | Units |
|---|---|---|
| Production Rate | 161 | kg/hr |
| Process Gas | O₂ | |
| Material Particle Size | 15 | μm (d50) |
| Residence Time | 4 | hrs |
| Temperature | 525 | ° C. |
| Material Output Temperature | ≤200 | ° C. |
| Material shaft Height | 6 | m |
| Material shaft Internal Diameter | 0.3 | m |
| Filtration Wall Material | Alumina | |
| Filtration Wall Pore Size | ≤1 | μm |
| Gas Flow Required (atm pressure) | 3 | m³/hr |
| Pressure Drop | 1.6 | Bar |

Various modifications, in addition to those shown and described herein, will be apparent to those skilled in the art of the above description. Such modifications are also intended to fall within the scope of the disclosure.

It is appreciated that all components are obtainable by sources known in the art unless otherwise specified.

Patents, publications, and applications mentioned in the specification are indicative of the levels of those skilled in the art to which the disclosure pertains. These patents, publications, and applications are incorporated herein by reference to the same extent as if each individual patent, publication, or application was specifically and individually incorporated herein by reference.

The foregoing description is illustrative of particular aspects of the invention, but is not meant to be a limitation upon the practice thereof.

1. A continuous processing chamber for the treatment of a material comprising:
a material shaft comprising an inlet and an outlet, the material shaft configured so that material introduced by the inlet may be transported through the material shaft and discharged through the outlet; and
an inner gas transfer tube in fluid communication with the material shaft, the inner gas transfer tube comprising an inner filtration wall that encases at least a portion of the inner gas transfer tube providing fluid communication with both the material shaft and the inner gas transfer tube; or
an outer gas transfer tube in fluid communication with the material shaft, the outer gas transfer tube comprising an outer gas transfer wall that encases at least a portion of the outer gas transfer tube and is in fluid communication with both the material shaft and the outer gas transfer tube; or
both an inner gas transfer tube and an outer gas transfer tube;
wherein the continuous processing chamber is configured to allow the gas fed through the inner or outer gas transfer tube to the material shaft to contact the material, thereby treating the material.

2. The continuous processing chamber of claim 1 further comprising a thermally-conductive shell that encases at least a portion of the material shaft, the inner gas transfer tube, the inner filtration wall, the outer filtration wall, the outer gas transfer tube, or combinations thereof.

3. The continuous processing chamber of claim 2, wherein the thermally-conductive shell comprises copper, aluminum, brass, silver, gold, iron, inconel, steel, or combinations thereof.

4. The continuous processing chamber of claim 1, wherein the material shaft forms an annulus around at least a portion of the inner gas transfer tube.

5. The continuous processing chamber of claim 4 wherein the outer gas transfer tube forms an annulus around at least a portion of the material shaft.

6. The continuous processing chamber of claim 1, wherein the inner filtration wall and the outer filtration wall are able maintain their structural integrity at temperatures greater than 500° C.

7. The continuous processing chamber of claim 1, wherein the inner filtration wall and the outer filtration wall comprise porous media.

8. The continuous processing chamber of claim 1, wherein the inner filtration wall and the outer filtration wall comprise a cement, ceramic, coated metal, or combinations thereof.

9. The continuous processing chamber of claim 8, wherein the ceramic is silicon carbide, alumina, silicon dioxide, mullite, or combinations thereof.

10. The continuous processing chamber of claim 1, wherein the outer filtration wall comprises an outer diameter from 100 mm to 750 mm.

11. The continuous processing chamber of claim 1, wherein the inner filtration wall and the outer filtration wall have a porosity from 10% to 90%.

12. The continuous processing chamber claim 1, wherein either the inner gas transfer tube or the outer gas transfer tube is tapered along a length of the material shaft.

13. The continuous processing chamber claim 1, wherein the inner gas transfer tube and the outer gas transfer tube are both tapered along a length of the material shaft.

14. The continuous processing chamber of claim 1, wherein the continuous processing chamber further comprises a cooling portion that at encases at least a portion of the thermally-conductive shell.

15. The continuous processing chamber of claim 1, further comprising a heating apparatus in thermal communication with the material shaft.

16. A method of treating the material using the continuous processing chamber of claim 1, the method comprising:
contacting a material in the material shaft with a gas to produce a lithiated product.

17. The method of claim 16, wherein the material is treated from 10 minutes to 24 hours.

18. The method of claim 16, wherein the material is treated at 500° C. to 2,400° C.

19. The method of any one of claim 16, wherein the gas comprises oxygen, nitrogen, argon, carbon dioxide, hydrogen, krypton, methane, ethane, propane, butane, helium, neon, or combinations thereof.

20. The method of claim 16, wherein lithiated product comprises lithium cobalt oxide, lithium manganese oxide, lithium nickel manganese cobalt oxide, lithium nickel cobalt manganese oxide, lithium nickel cobalt magnesium oxide, lithium iron phosphate, lithium nickel cobalt aluminum oxide, lithium titanate, or combinations thereof.

21. The method of claim 16, wherein lithiated product comprises nickel at greater than or equal to 80 at. %, based on the entire atomic weight of metal within the lithiated product.

22. The method of claim 16 wherein the material comprises a plurality of particles.

23. The method of claim 16 further comprising introducing the material to the material shaft by the inlet and discharging the material through the outlet.

24. The method of claim 23 wherein the gas has a flow direction is orthogonal to a flow direction of the material.

25. The method of claim 16 wherein the gas is introduced to the material shaft at more than one location.
